(19) United States
(12) Patent Application Publication
(10) Pub. No.: US 2010/0162337 A1
(43) Pub. Date: Jun. 24, 2010

(54) APPARATUS AND METHOD FOR PROCESSING VIDEO SERVICE FLOW USING DUAL SCHEDULER FOR HEADEND CABLE MODEM IN HFC NETWORK

(76) Inventors: Ho-Sook LEE, Daejeon (KR); O Hyung KWON, Daejeon (KR); Soo In LEE, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/546,889

(22) Filed: Aug. 25, 2009

(30) Foreign Application Priority Data
Dec. 19, 2008 (KR) 10-2008-0130230

(51) Int. Cl. H04N 7/173

(52) U.S. Cl. 725/111

(57) ABSTRACT

Provided is an apparatus and method for providing a video service flow using a dual scheduler for a headend cable modem in a Hybrid Fiber Coax (HFC) network. The apparatus may include: a service flow processing unit to determine whether a packet corresponds to a registered video service flow, when the packet is received; and at least one channel transmitter to schedule a packet corresponding to the registered video service flow and a packet not corresponding to the registered video service flow so that a transmission rate of the registered video service flow is guaranteed, and to thereby transmit the packets.

### CROSS-REFERENCE TO RELATED APPLICATION

This application claims the benefit of Korean Patent Application No. 10-2008-0130230, filed on Dec. 19, 2008, in the Korean Intellectual Property Office, the disclosure of which is incorporated herein by reference.

### BACKGROUND

1. Field of the Invention

The present invention relates to an input packet processing apparatus that may effectively transmit a video data stream, input from an Internet Protocol (IP) network, in a headend cable modem of a Hybrid Fiber Coax (HFC) network based on a Data Over Cable Service Interface Specification (DOCSIS), and a method of processing a service flow.

2. Description of the Related Art

A signal representing data for a digital video service may be modulated to a frequency channel using Edge-quadrature amplitude modulation (QAM) transmission equipment in a Hybrid Fiber Coax (HFC) cable network comprising a service distribution network. The data may then be transmitted in an MPEG-2 Transport Stream (TS) packet stream from a video server of a service provider network to a subscriber network. Existing video transmission services generally include video broadcasting services based on a broadcast transmission scheme. Therefore, a single program may be transmitted over each single frequency channel of a cable network and thereby be broadcast in a subscriber cell of the cable network. Currently, various types of transmission schemes are used and various types of services are provided, for example, a multicast video transmission service such as a Switched Digital Video (SDV) service suitable for supplying a video service only for a limited subscriber group, a user demanded service such as a Video on Demand (VoD) service and a video conference service, and the like. A transmission network structure based on the existing broadcast transmission schemes may not be suitably adapted to various types of emerging and complex two-way services such as an Internet Protocol Television (IPTV). Accordingly, there is a need to transfer a video service flow using a Data Over Cable Service Interface Specification (DOCSIS) based transmission system of a cable network transferring a data service flow. Using a DOCSIS based transmission system to transfer a video service flow, it is possible to allow various types of video service flows such as a broadcast transmission type, a multicast type, a demand type, and a two-way type.

The DOCSIS based transmission system is a network that is generally constructed for a data service flow. Accordingly, the DOCSIS based transmission system may adopt a best effort transmission scheme based on a statistical multiplexing transmission between channel queues. Although a quality secured transmission scheme using a priority order queue is applied, there may be some constraints to accept the video service flow due to a transmission scheduling policy and a dynamic band allocation allowing a retransmission.

### SUMMARY

An aspect of the present invention provides an apparatus and method for providing a video service flow using a dual scheduler for a headend cable modem in a Hybrid Fiber Coax (HFC) network.

Another aspect of the present invention also provides an input packet processing apparatus that may effectively transmit a video data stream, input from an Internet Protocol (IP) network, in a headend cable modem of an HFC network, and a method of processing a service flow.

Another aspect of the present invention also provides an apparatus and method for processing a video service flow that may classify an input packet into a video service flow and a data service flow, and thereby schedule the data service flow to not affect a transmission rate of the video service flow.

Another aspect of the present invention also provides an apparatus and method for processing a video service flow that may maintain a video transmission rate using a dual scheduler scheme, without being affected by a change in a transmission rate of a data service flow. Here, the dual scheduler scheme denotes a scheme that may classify the video service flow of a data stream and allocate a dedicated video service flow queue for each channel to thereby schedule a downlink transmission separately from the data service flow.

According to an aspect of the present invention, there is provided an apparatus for processing a video service flow of a headend cable modem, the apparatus including: a service flow processing unit to determine whether a packet corresponds to a registered video service flow, when the packet is received; and at least one channel transmitter to schedule a packet corresponding to the registered video service flow and a packet not corresponding to the registered video service flow so that a transmission rate of the registered video service flow is guaranteed, and to thereby transmit the packets.

According to another aspect of the present invention, there is provided a method of processing a video service flow of a headend cable modem, the method including: determining whether a packet corresponds to a registered video service flow, when the packet is received; and scheduling a packet corresponding to the registered video service flow and a packet not corresponding to the registered video service flow so that a transmission rate of the registered video service flow is guaranteed, to thereby transmit the packets.

### Effect

According to embodiments of the present invention, there may be provided an apparatus and method for processing a video service flow using a dual scheduler for a headend cable modem in a Hybrid Fiber Coax (HFC) network, the apparatus including: a service flow processing unit to determine whether a packet corresponds to a registered video service flow, when the packet is received; and at least one channel transmitter to schedule a packet corresponding to the registered video service flow and a packet not corresponding to the registered video service flow so that a transmission rate of the registered video service flow is guaranteed, and to thereby transmit the packets. When a service flow for a video transmission is input, it is possible to identify the service flow during a packet classification process, and to allocate a separate transmission scheduler and a channel transmission queue. Through this, it is possible to guarantee a transmission band and quality for a transmission of the video service flow.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a transmission structure of a Hybrid Fiber Coax (HFC) network according to an embodiment of the present invention;

FIG. 2 is a diagram illustrating an example of processing a service flow in a headend cable modem according to an embodiment of the present invention;

FIG. 3 is a diagram illustrating a structure of a headend cable modem processing a service flow using a dual scheduler according to an embodiment of the present invention;

FIG. 4 is a block diagram illustrating a detailed structure of a headend cable modem processing a service flow using a dual scheduler according to an embodiment of the present invention; and

FIG. 5 is a flowchart illustrating a method of processing a service flow in a headend cable modem using a dual scheduler according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

Hereinafter, embodiments of the present invention will be described in detail with reference to the accompanying drawings. When it is determined detailed description related to a known function or configuration they may render the purpose of the present invention unnecessarily ambiguous in describing the present invention, the detailed description will be omitted here.

According to an embodiment of the present invention, disclosed is an apparatus and method for processing a video service flow that may maintain a video transmission rate using a dual scheduler scheme, without being affected by a change in a transmission rate of a data service flow. Here, the dual scheduler scheme denotes a scheme that may classify the video service flow of a data stream and allocate a dedicated video service flow queue for each channel to thereby schedule a downlink transmission separately from the data service flow.

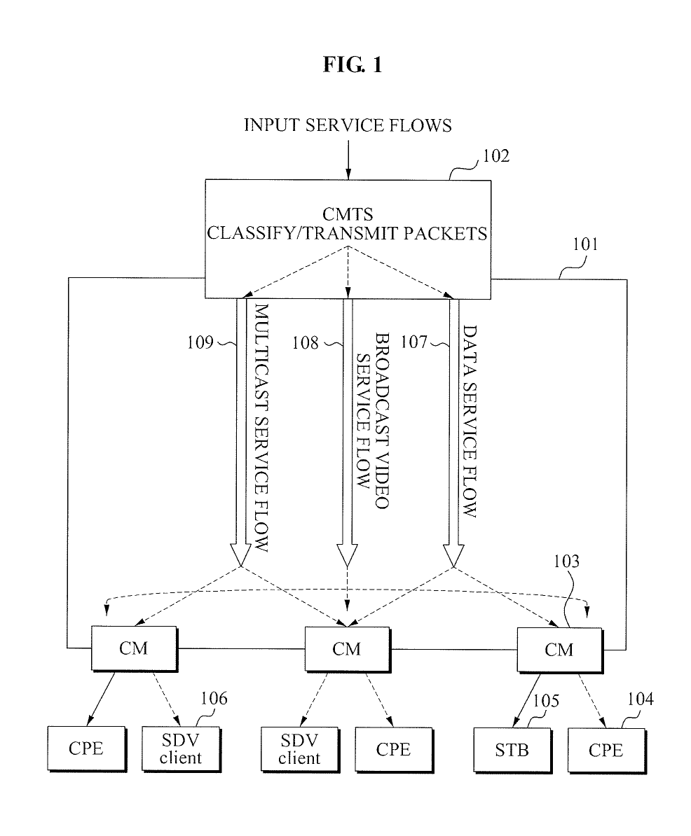

FIG. 1 is a diagram illustrating a transmission structure of a Hybrid Fiber Coax (HFC) network 101 according to an embodiment of the present invention.

As shown in FIG. 1, the HFC network 101, as a service distribution network, may receive service flows that are input from an Internet Protocol (IP) network to a cable network, using a cable modem termination system (CMTS) 102, change the received service flows into a form of a Data Over Cable Service Interface Specification (DOCSIS) based packet, and thereby transfer the changed service flows to a cable modem (CM) 103 of a subscriber side via a frequency channel of the HFC network 101. The service flows input from the IP network to the CMTS 102 correspond to frames that follow an Institute of Electrical and Electronics Engineers (IEEE) 802.3/DEC-Intel-Xerox (DIX) standard. The data packets include various types of data according to service flow characteristics. The CMTS 102 may classify packet streams for each service flow, and process the classified packet streams according to a corresponding service flow transmission characteristic. Next, the CMTS 102 may reassemble the packet streams into a DOCSIS packet, and allocate a transmission channel to the reassembled service flows of the DOCSIS packet, and transmit the service flows to the CM 103 via the allocated transmission channel. The service flows to be transmitted from the CMTS 102 may be classified into a data service flow that is transferred to a particular Customer Premise Equipment (CPE) 104 or a CM, a broadcast video service flow 108 that is broadcast to all the CMs, and a multicast service flow 109 that is transmitted to only a particular CM group. Here, a video service flow may use various types of transmission service schemes. Generally, the video service flow may be transferred, using the broadcast video service flow 108 or the multicast service flow, to a set-top-box (STB) 105 or a Switched Digital Video (SDV) client 106 that is connected to the CM.

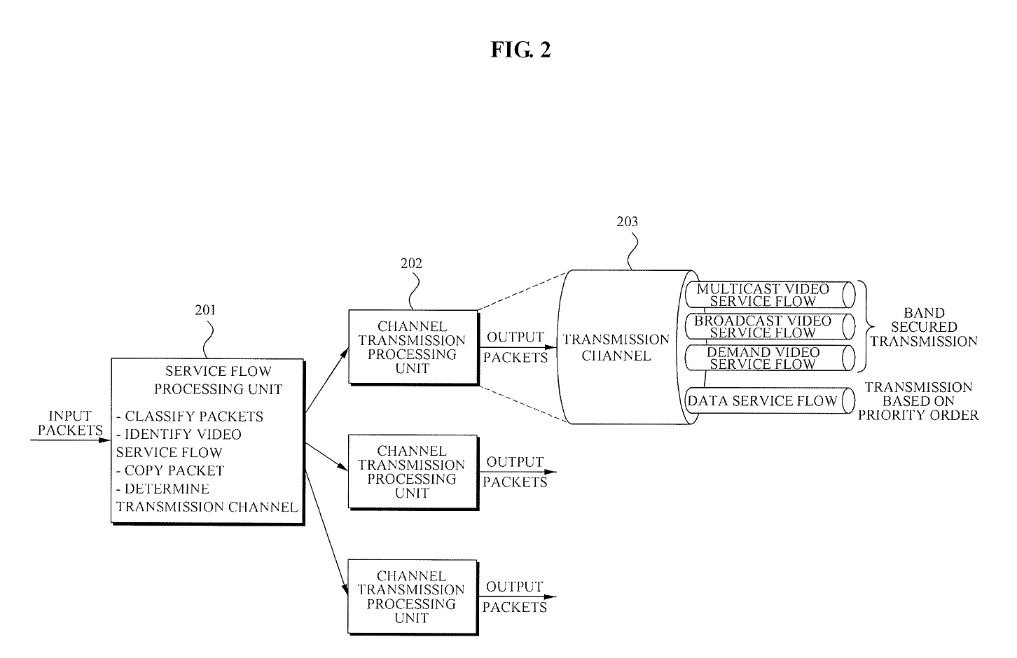

FIG. 2 is a diagram illustrating an example of processing a service flow in a headend cable modem according to an embodiment of the present invention.

Referring to FIG. 2, a CTMS may be the headend cable modem proposed by the present invention. The CMTS may include a service flow processing unit 201 and a plurality of channel transmission processing units to transmit a video service flow or a data service flow via a transmission channel 203.

The service flow processing unit 201 of the headend cable modem may need to classify packets, input from an IP network, into a corresponding service flow. Here, types of the service flow may include a multicast video service flow, a broadcast video service flow, a demand video service flow, and a data service flow. In particular, the service flow processing unit 201 may identify a registered video service flow for a separate transmission control with respect to the video service flow. Also, when a corresponding packet corresponds to a multicast service flow that may need to be transmitted to a limited subscriber group., the service flow processing unit 201 may copy the packet according to a topology of an HFC network in order to prevent a duplicate transmission from occurring within a service group. Also, the service flow processing unit 201 may assign a different downlink transmission service identifier to the packet.

When the corresponding packet is classified into its corresponding service flow, the service flow processing unit 201 may determine a downlink channel to transmit the packet based on a transmission characteristic of the corresponding service flow and available channel resource information. The service flow processing unit 201 may add, in the packet, information required for a DOCSIS header and packet scheduling, and transfer the packet to a video transmission queue or a data transmission queue that is a transmission standby queue of a corresponding channel.

The channel transmission processing unit 202 may operate a video transmission queue that is a dedicated standby queue with respect to the video service flow, and a data transmission queue for each priority order with respect to a general data service flow. The channel transmission processing unit 202 may schedule a channel transmission so that a transmission rate reserved for each service flow may be guaranteed, and thereby output the packet in a channel queue. Based on a priority, the data service flow, and the video service flow with a secured band, for example, a multicast video service flow, a broadcast video service flow, and a demand video service flow, may be multiplexed and thereby be included in a frequency channel transmitted from the headend cable modem to a cable modem of a cable network.

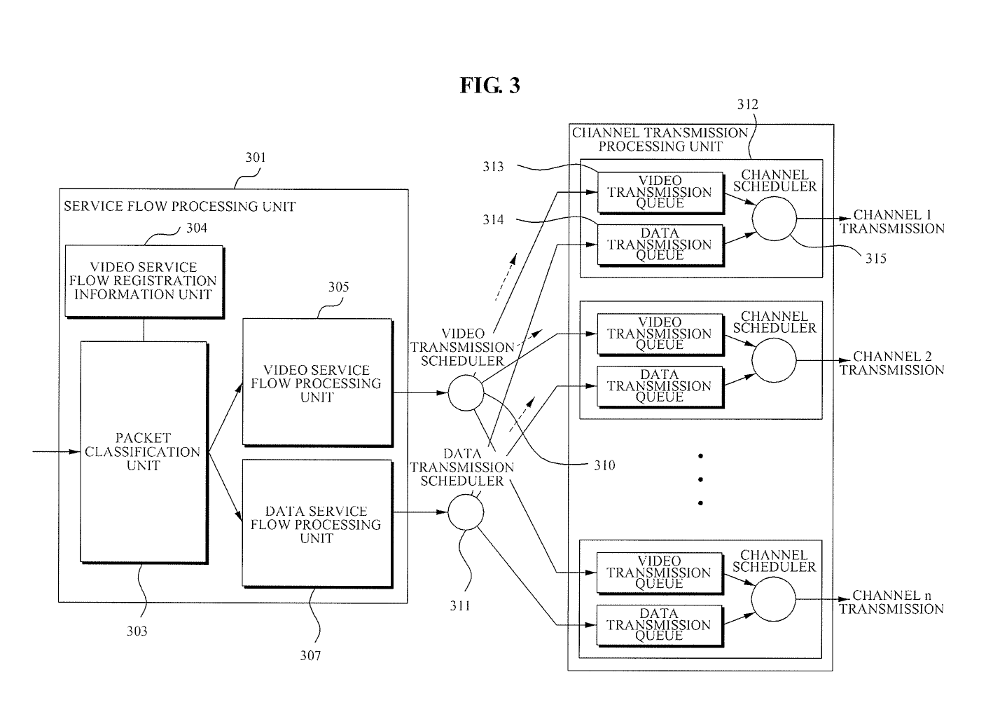

Hereinafter, a structure of processing an input packet using a dual scheduling scheme in order to effectively process a video service flow in a headend cable modem, that is, a CMTS according to an embodiment of the present invention will be described with reference to FIG. 3.

FIG. 3 is a diagram illustrating a structure of a headend cable modem processing a service flow using a dual scheduler according to an embodiment of the present invention. The headend cable modem processing an input packet may include a service flow processing unit 301, a video transmission scheduler 310, a data transmission scheduler 311, and a plurality of channel transmission processing units 312.

The service flow processing unit 301 may classify a service flow of a packet, input from an IP network, into a corresponding service flow, and determine a transmission priority order and a channel for transmitting the packet to a terminal CM according to a transmission characteristic of the corresponding service flow. Specifically, the service flow processing unit 301 may perform a scheduling function. The channel transmission processing unit 312 may queue and transmit packets to be transmitted via a corresponding frequency channel, according to the transmission priority order.

According to an embodiment of the present invention, in order to decrease a delay and a change in a transmission rate that may occur when video service flows are scheduled together with best effort services, the video service flows may be separately classified and be scheduled.

The service flow processing unit 301 may include a packet classification unit 303, a video service flow registration information unit 304, a video service flow processing unit 305, and a data service flow processing unit 307.

The video service flow registration information unit 304 may store pre-registered video service flow information. The packet classification unit 303 may classify a service flow of a packet using the video service flow registration information unit 304.

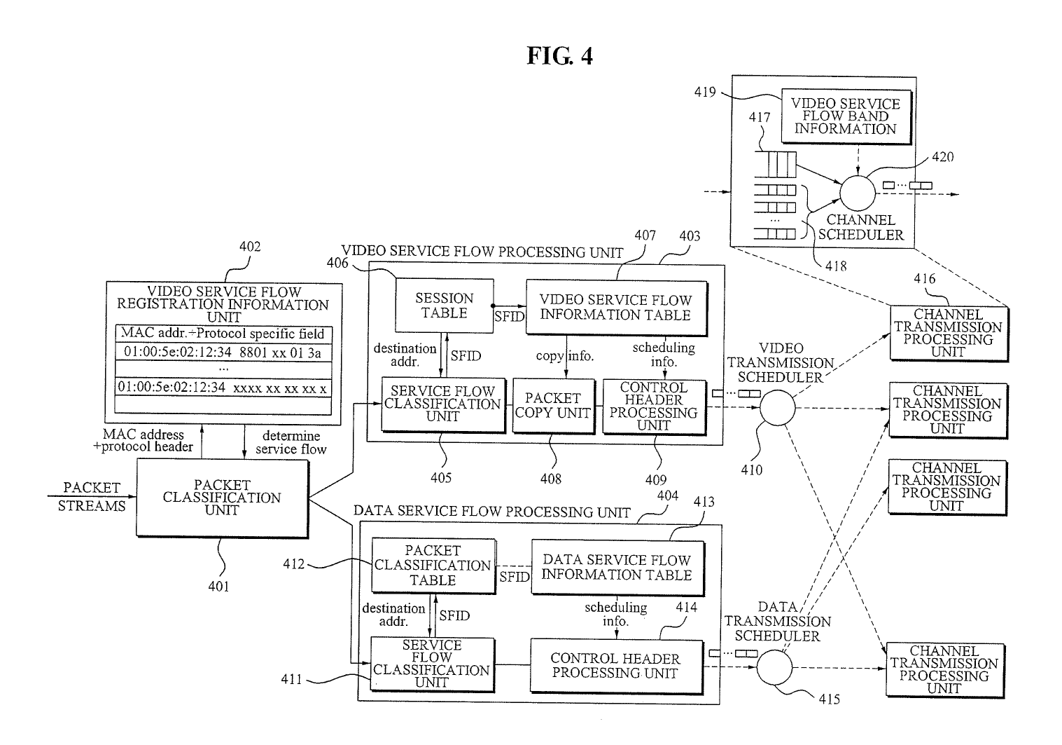

When the packet corresponds to a registered video service flow, the video service flow processing unit 305 may perform a corresponding process and output the packet to the video transmission scheduler 310. Conversely, when the packet does not correspond to the registered video service flow, the data service flow processing unit 307 may perform a corresponding process and then output the packet to the data transmission scheduler 311. An operation of the video service flow processing unit 305 and the data service flow processing unit 307 will be described in detail with reference to FIG. 4.

When packets are received from the service flow processing unit 301, the video transmission scheduler 310 and the data transmission scheduler 311 may schedule the packets according to a current queue standby status of a transmission channel and a priority order, and output the scheduled packets to the channel transmission processing unit 312.

The channel transmission processing unit 312 may support two types of transmission queues. Specifically, the channel transmission processing unit 312 may queue, into a video transmission queue 313, a packet that is classified into the video service flow, and may queue, into a data transmission queue 314, a packet that is classified into the data service flow. Here, in addition to the packet classified into the data service flow, a packet of a service flow that is unregistered as the video service flow may be also queued in the data transmission queue 314. The channel transmission scheduler 315 of the channel transmission processing unit 312 may schedule transmission standby packets of a video service flow transmission queue and a data service flow transmission queue to thereby transmit the scheduled packets via a corresponding frequency channel.

FIG. 4 is a block diagram illustrating a detailed structure of a headend cable modem processing a service flow using a dual scheduler according to an embodiment of the present invention.

Referring to FIG. 4, the headend cable modem may include a packet classification unit 401, a video service flow registration information unit 402, a video service flow processing unit 403 a data service flow processing unit 404, a video transmission scheduler 410, a data transmission scheduler 415, and a channel transmission processing unit 416.

The packet classification unit 401 may refer to the video service flow registration information unit 402 to classify a video service flow. The video service flow registration information unit 402 may store information to identify a service flow requiring a strict guaranty for a transmission rate and a transmission quality. Specifically, the video service flow registration information unit 402 may store information used to identify a service flow that needs to obtain a predetermined band. Also, the video service flow registration information unit 402 may include a particular protocol field of a packet header such as a destination Media Access control (MAC) address, a destination port identifier, and a protocol identifier, to make it possible to identify a service flow of a corresponding packet.

The packet classification unit 401 may mask a particular field for identifying a service flow, and extract header information from a header of the input packet. The packet classification unit 401 may search the video service flow registration information unit 402 using the extracted header information to thereby determine whether the input packet corresponds to a registered video service flow.

When the packet corresponds to the registered video service flow, the packet classification unit 401 may transfer the packet to the video service flow processing unit 403. Conversely, when the packet does not correspond to the registered video service flow, the packet classification unit 401 may transfer the packet to the data service flow processing unit 404.

The video service flow processing unit 403 may include a service flow classification unit 405, a session table 406, a video service flow information table 407, a packet copy unit 408, and a control header processing unit 409.

The service flow classification unit 405 may determine whether the input packet corresponds to a multicast service flow, using the session table 406. The session table 406 may provide service flow identifier information corresponding to information associated with a service group to be transferred to a destination group MAC address of the packet. When the input packet corresponds to a multicast or broadcast service flow as a verification result of the service flow identifier, the service flow classification unit 405 may request the packet copy unit 408 to copy the packet. The packet copy unit 408 may copy the packet by referring to the service flow information table 407.

The control header processing unit 409 may construct, by referring to the video service flow information table 407, a control header that includes available channel information and a downlink service identifier. The control header processing unit 409 may process a header of the packet to be transmitted together with a DOCSIS header, and transfer the packet to the video transmission scheduler 410. Here, the video transmission scheduler 410 may verify, from the control header of the packet, a channel resource reserved for a transmission of the packet, and input the packet into a video transmission queue 417 of a corresponding channel.

The data service flow processing unit 404 may include a service flow classification unit 411, a packet classification table 412, a data service flow information table 413, and a control header processing unit 414.

The service flow classification unit 411 may retrieve service flow identifier information of a corresponding packet, using a destination MAC address and header information of the packet, by referring to the service flow classification table 413.

The control header processing unit 414 may construct, by referring to the data service flow information table 413, a control header that includes available channel information and a downlink service identifier. The control header processing unit 414 may process a header of the packet to be transmitted together with a DOCSIS header, and transfer the packet to the data transmission scheduler 415. Here, the data transmission scheduler 415 may select, from the control header of the packet, a data transmission queue according to a priority order of an available channel, among channel resources reserved for transmission of the packet, and input the selected data transmission queue into a data transmission queue 418 of the channel transmission processing unit 416.

The channel transmission processing unit 416 may include the video transmission queue 417, a plurality of data transmission queues 418, a video service flow band information unit 19, and a channel scheduler 420.

The video service flow band information unit 419 may store band information where the video service flow may be transmitted. The channel scheduler 420 may schedule an output of the video transmission queue 417 and an output of the data transmission queue 418. Initially, the channel scheduler 420 may schedule the packet stored in the video transmission queue 417 so that a transmission rate thereof may be guaranteed, and may also schedule a packet of the data transmission queue 418 according to a priority order of the data transmission queue 418 using a utilization rate of the remaining band. In this instance, the transmission rate of the packet stored in the video transmission queue may be verified from the video service flow band information 419.

In this instance, a scheduling algorithm for a decision of a transmission channel and interleaving between transmission queues may be designed to enhance a channel utilization efficiency.

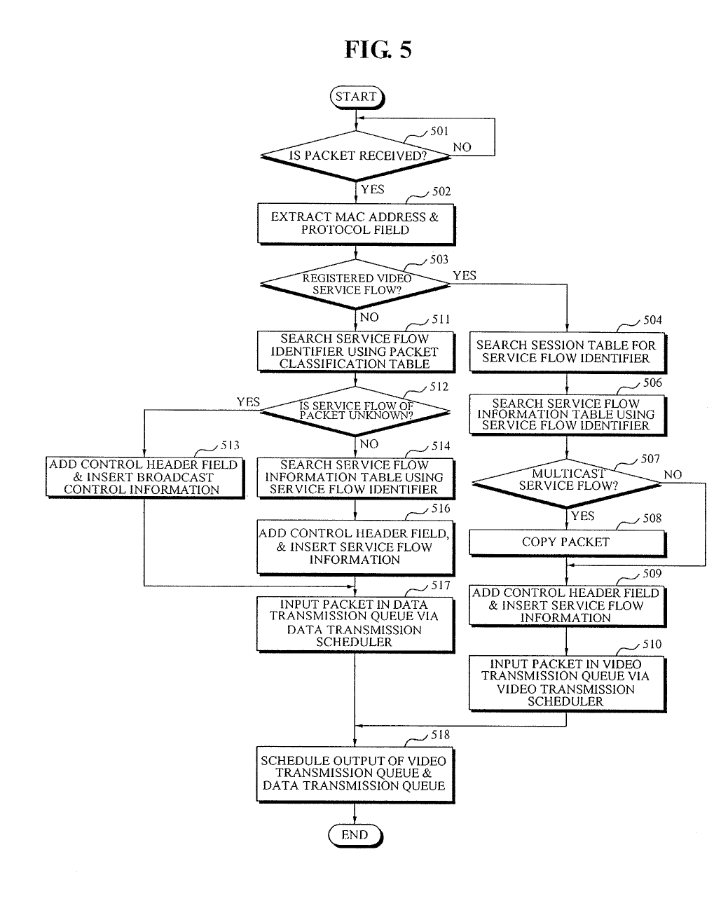

Hereinafter, a method of processing a video service flow using a dual scheduler for a headend cable modem in an HFC network according to an embodiment of the present invention will be described in detail with reference to FIG. 5.

FIG. 5 is a flowchart illustrating a method of processing a service flow using a dual scheduler in a headend cable modem according to an embodiment of the present invention.

Referring to FIG. 5, when a packet is received in operation 501, the headend cable modem may extract an MAC address and a protocol field from the packet in operation 502. In operation 503, the headend cable modem may search a video service flow registration information unit to determine whether the packet corresponds to a registered video service flow.

When the packet corresponds to the registered video service flow in operation 503, the headend cable modem may search a session table for a service flow identifier of the packet in operation 504, and may search a service flow information table using the service flow identifier in operation 506.

In operation 507, the headend cable modem may determine whether the packet corresponds to a multicast service flow needing a packet copy, using the search result of the service flow information table. When the packet corresponds to the multicast service flow in operation 507, the headend cable modem may copy the packet in operation 508.

In operation 509, the headend cable modem may add, in the packet, a DOCSIS header field and a packet transmission control header field such as a downlink service identifier and a transmission channel obtained from the service flow information table. In operation 510, the headend cable modem may input the packet, including the control header, in a video transmission queue of a channel transmission processing unit, using a video transmission scheduler, and then proceed to operation 518. In this instance, the video transmission scheduler may verify a channel resource, reserved for a packet transmission, from the control header of the packet and thereby input the packet in a video transmission queue of a corresponding channel via which the packet is transmitted.

Conversely, when the packet does not correspond to the registered video service flow in operation 503, the headend cable modem may retrieve a service flow identifier using a packet classification table in operation 511. In operation 512, the headend cable modem may verify whether the packet is a packet of which a service flow identifier is not retrieved and thereby unknown.

When the packet is the packet of which the service flow identifier is not retrieved in operation 512, the headend cable modem may add a control header field to the packet, and insert broadcast control information in operation 513.

Conversely, when the packet is the packet of which the service flow identifier is retrieved and thereby known in operation 512, the head end cable modem may search a service flow information table using the service flow identifier in operation 514. In operation 516, the headend cable modem may add, in the packet, a DOCSIS header field and a control header field such as an available channel group and a downlink service identifier with respect to a packet transmission, using the retrieved information. Also, the headend cable modem may insert service flow information.

After operation 513 or 516, the headend cable modem may input the packet containing the control header, in a data transmission queue of the channel transmission processing unit using a data transmission scheduler in operation 517. In this instance, the data transmission scheduler may select the data transmission queue from the control header of the packet according to a priority order of an available channel among channel resources reserved for the packet transmission, and input the selected data transmission queue in the data transmission queue of the channel transmission processing unit.

After operation 510 or 517, the headend cable modem may schedule an output of the video transmission queue and the data transmission queue to guarantee a transmission rate of the video service flow in operation 518.

The above-described exemplary embodiments of the present invention may be recorded in computer-readable media including program instructions to implement various operations embodied by a computer. The media may also include, alone or in combination with the program instructions, data files, data structures, and the like. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for processing a video service flow of a headend cable modem, the apparatus comprising:
a service flow processing unit to determine whether a packet corresponds to a registered video service flow, when the packet is received; and
at least one channel transmitter to schedule a packet corresponding to the registered video service flow and a packet not corresponding to the registered video service flow so that a transmission rate of the registered video service flow is guaranteed, and to thereby transmit the packets.

2. The apparatus of claim 1, further comprising:
a video transmission scheduler to identify a channel resource, reserved for a packet transmission, from a control header of the packet corresponding to the registered video service flow, and to provide the verified channel resource to a channel transmitter of a corresponding channel for transmitting the packet corresponding to the registered video service flow, when the packet corresponding to the registered video service flow is received from the service flow processing unit; and
a data transmission scheduler to provide the packet not corresponding to the registered video service flow to a channel transmitter of an available channel, among channel resources reserved for the packet transmission, identified from a control header of the packet not corresponding to the registered video service flow, when the packet not corresponding to the registered video service flow is received from the service flow processing unit.

3. The apparatus of claim 1, wherein the service flow processing unit comprises:
a packet classification unit to determine whether the received packet corresponds to the registered video service flow, based on header information of the received packet;
a video service flow processing unit to process the packet corresponding to the registered video service flow; and
a data service flow processing unit to process the packet not corresponding to the registered video service flow.

4. The apparatus of claim 3, wherein the video service flow processing unit comprises:
a session table to store service flow identifier information corresponding to information associated with a service group that is transmitted to a destination group Media Access Control (MAC) address of the packet;
a service flow classification unit to determine whether the packet corresponding to the registered video service flow corresponds to a video service flow providing a multicast service, using the session table;
a video service flow information table to store information associated with the registered video service flow;
a packet copy unit to copy the packet corresponding to the registered video service flow for a multicast, by referring to the video service flow information table, when the packet corresponding to the registered video service flow corresponds to the video service flow providing the multicast service; and
a control header processing unit to construct, by referring to the video service flow information table, a control header that includes available channel information and a downlink service identifier, and to add the control header in the packet corresponding to the registered video service flow.

5. The apparatus of claim 1, wherein each of the at least one channel transmitter comprises:
a video service flow band information unit to store band information used to transmit the video service flow;
a video transmission queue to apply a first in first out (FIFO) scheme to packets corresponding to the registered video service flow;
a plurality of data transmission queues to classify packets not corresponding to the registered video service flow according to a priority order, and to apply the FIFO scheme to the classified packets; and
a channel scheduler to schedule a transmission of the video transmission queue so that a transmission rate of the packet corresponding to the registered video service flow is guaranteed, within the range guaranteed by video service flow band information stored in the video service flow band information unit.

6. The apparatus of claim 5, wherein the channel scheduler schedules a channel transmission according to a priority order of each of the data transmission queues based on a band utilization rate.

7. A method of processing a video service flow of a headend cable modem, the method comprising:
determining whether a packet corresponds to a registered video service flow, when the packet is received; and
scheduling a packet corresponding to the registered video service flow and a packet not corresponding to the registered video service flow so that a transmission rate of the registered video service flow is guaranteed, to thereby transmit the packets.

8. The method of claim 7, wherein the determining comprises:
determining whether the received packet corresponds to the registered video service flow, based on header information of the received packet;
providing the received packet to a video transmission scheduler, when the received packet corresponds to the registered video service flow; and
providing the received packet to a data transmission scheduler, when the received packet does not correspond to the registered video service flow.

9. The method of claim 8, wherein, when the packet corresponding to the registered video service flow is received, the video transmission scheduler identifies a channel resource, reserved for a packet transmission, from a control header of the packet corresponding to the registered video service flow, to provide the identified channel resource to a channel transmitter of a corresponding channel for transmitting the packet corresponding to the registered video service flow.

10. The method of claim 8, wherein, when the packet not corresponding to the registered video service flow is received, the data transmission scheduler provides the packet not corresponding to the registered video service flow to a channel transmitter of an available channel, among channel resources reserved for the packet transmission, identified from a control header of the packet not corresponding to the registered video service flow.

11. The method of claim 8, wherein the providing of the packet corresponding to the registered video service flow comprises:
verifying service flow identifier information of the packet corresponding to the registered service flow;
constructing, by referring to a video service flow information table, a control header that includes available channel information and a downlink service identifier; and
adding the control header in the packet corresponding to the registered video service flow to provide to the video transmission scheduler.

12. The method of claim 11, further comprising:
determining whether the packet corresponding to the registered video service flow corresponds to a video service flow providing a multicast service; and
copying the packet corresponding to the registered video service flow for a multicast, when the packet corresponding to the registered video service flow corresponds to the video service flow corresponding to the multicast service.
